(19) United States
(12) Patent Application Publication
(10) Pub. No.: US 2016/0011881 A1
(43) Pub. Date: Jan. 14, 2016

(54) INFORMATION PROCESSING DEVICE, INFORMATION PROCESSING METHOD, AND STORAGE MEDIUM

(71) Applicant: FUJI XEROX CO., LTD., Tokyo (JP)

(72) Inventors: Fumihisa SUZUKI, Kanagawa (JP); Toshiyuki MAEZAWA, Kanagawa (JP)

(73) Assignee: FUJI XEROX CO., LTD., Tokyo (JP)

(21) Appl. No.: 14/610,325

(22) Filed: Jan. 30, 2015

(30) Foreign Application Priority Data
Jul. 10, 2014 (JP) 2014-142063

(51) Int. Cl. G06F 9/44; G06F 9/50; G06F 9/445

(52) U.S. Cl. CPC G06F 9/4401; G06F 9/44505; G06F 9/5011

(57) ABSTRACT

An information processing device includes a providing unit that provides at least one function by executing a program, a concurrently executable number of the program being limited, the providing unit being configured to provide the function by using at least one resource corresponding to the function; and a boot management unit that boots the program when the function is requested to be provided if the resource is available and an execution number of the program does not exceed the limit.

### CROSS-REFERENCE TO RELATED APPLICATIONS

This application is based on and claims priority under 35 USC 119 from Japanese Patent Application No. 2014-142063 filed Jul. 10, 2014.

### BACKGROUND

The present invention relates to an information processing device, an information processing method, and a storage medium.

### SUMMARY

According to an aspect of the invention, there is provided at least one information processing device including a providing unit that provides at least one function by executing at least one program, a concurrently executable number of the program being limited, the providing unit providing the function by using at least one resource corresponding to the function; and a boot management unit that boots the program when the function is requested to be provided if the resource is available and an execution number of the program does not exceed the limit. The resources include a hardware resource used for providing the function.

### BRIEF DESCRIPTION OF THE DRAWINGS

An exemplary embodiment of the present invention will be described in detail based on the following figures, wherein:

FIG. 1 illustrates a general configuration of an information processing system;

FIG. 2 illustrates a hardware configuration of an image processing device;

FIG. 3 illustrates a hardware configuration of an information managing device;

FIG. 4 illustrates a hardware configuration of a license managing device;

FIG. 5 illustrates a functional configuration of the image processing device;

FIG. 6 illustrates an example of a user information table;

FIG. 7 illustrates an example of a resource state table;

FIGS. 8A to 8D each illustrate an example of a license management table;

FIG. 9 illustrates an example of a sequence in providing processing;

FIG. 10 illustrates an example of a sequence after reservation;

FIG. 11 illustrates an example of another sequence after reservation;

FIG. 12 illustrates an example of a user information table according to a modification;

FIG. 13 illustrates an example of a resource state table according to a modification;

FIG. 14 illustrates a configuration of an information processing system according to a modification;

FIG. 15 illustrates an example of a resource state table according to a modification; and

FIG. 16 illustrates an example of a functional configuration of an information processing system according to a modification.

### DETAILED DESCRIPTION

### 1. Exemplary Embodiment

### 1-1. Configuration

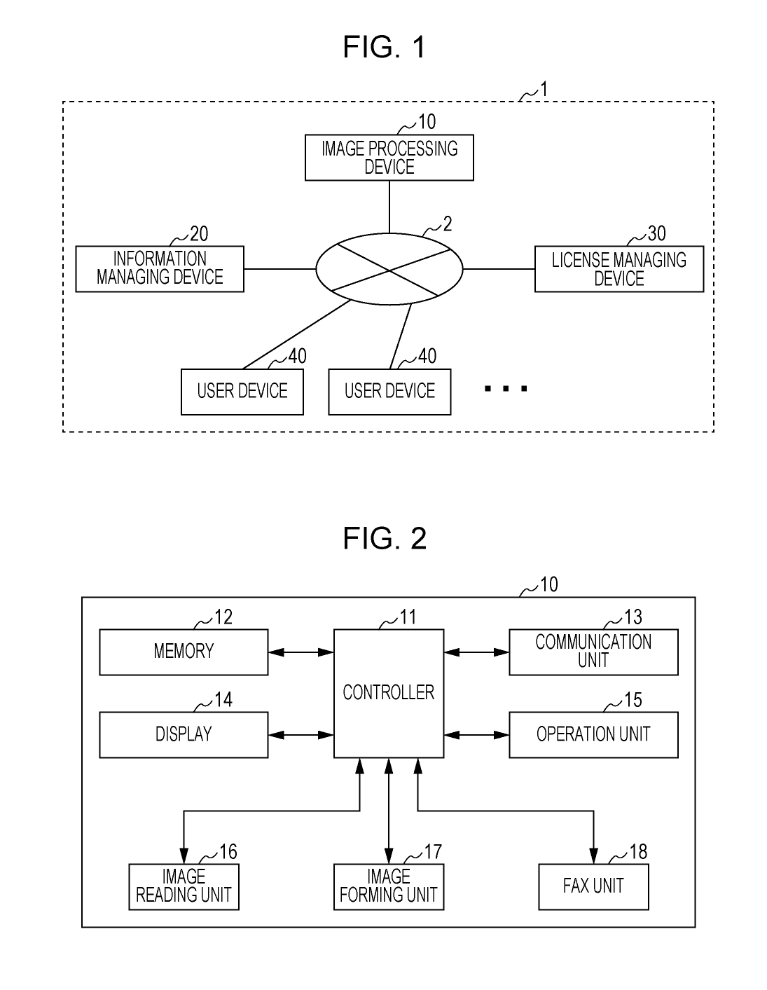

FIG. 1 illustrates a general configuration of an information processing system 1. The information processing system 1 provides at least one function of processing, for example, an image (hereinafter, referred to as “image processing function”). The at least one image processing function may include a copy function, a scan function, a FAX (facsimile) function, and a print function (function of outputting data of an image or a document to a medium). The information processing system 1 includes an image processing device 10, an information managing device 20, a license managing device 30, and plural user devices 40.

The image processing device 10 has the above-described image processing functions. The image processing device 10 also has a function of authenticating a user. The image processing device 10 authenticates a user based on a user ID (identifier) that is information for identifying a user, and a password. The image processing device 10 provides the image processing functions for the authenticated user. That is, a user performs a log-in operation that allows the user to be authenticated by using a user ID and a password, and then uses the image processing functions. Alternatively, the user authentication may be executed by other method, for example, by using an IC (integrated circuit) card capable of short-range communication, or biological information (fingerprint or voice pattern). The user may perform a log-in operation on the image processing device 10 or the user device 40.

The plural user devices 40 are computers, such as personal computers or tablet terminals, used by users. The image processing device 10 authenticates the user who operates the relevant device, and plural respective users who use the plural user devices 40. The image processing device 10 provides the image processing functions for users authenticated by the user authentication function. Even when plural users concurrently perform log-in, the image processing device 10 authenticates each of the users. If there are plural authenticated users, the image processing device 10 concurrently provides the image processing functions for the plural users.

The image processing device 10 stores a program group for providing the image processing functions. The program group includes, for example, firmware installed before shipping and a plug-in added later to expand the functions. Each image processing function is provided when required one of the programs is executed. For example, when the copy function is provided, a program A that reads an image and a program B that forms an image on a medium are executed. When the scan function is provided, the program A is executed. Also, when the FAX function is provided, a program C that controls a FAX modem is executed. When the print function is provided, the program B is executed.

In the information processing system 1, all the users are not provided with all the image processing functions. The image processing functions to be provided are determined depending on the user. For example, the copy function and the scan function are provided for a user α, the scan function is provided for a user β, and the FAX function is provided for a user γ. The functions to be provided are different depending on the user, and the programs to be executed are different depending on the user. For example, when the copy function and the scan function are provided for the user α, the programs A and B are executed. When the scan function is provided for the user β, the program A is executed. When the FAX function is provided for the user γ, the program C is executed. The information managing device 20 manages information indicative of which program is executed when a function is provided for each user. For example, the information managing device 20 stores information of a user ID being the above-described user identification information, and information of a program ID being program identification information.

A program may require a license (right to use the program). The programs to be executed by the image processing device 10 may include a program provided in a license form (so-called floating license) in which boot of software is permitted within a range of the number of permitted licenses, i.e., the concurrently available number is limited. The license managing device 30 manages licenses of programs the concurrently executable number of which is limited (hereinafter, referred to as “limited program”). The license managing device 30 stores information of, for example, the residual concurrently executable number of limited programs (hereinafter, referred to as “executable number”). The image processing device 10, the information managing device 20, and the license managing device 30 are connected to each other through a communication line 2, and transmit and receive information such as the user ID, the program ID, and the executable number.

FIG. 2 illustrates a hardware configuration of the image processing device 10. The image processing device 10 is a computer including a controller 11, a memory 12, a communication unit 13, a display 14, an operation unit 15, an image reading unit 16, an image forming unit 17, and a FAX unit 18. The controller 11 includes a CPU (central processing unit), a RAM (random access memory), and a ROM (read only memory). The controller 11 controls operations of the respective units when the CPU executes programs stored in the ROM or the memory 12. The memory 12 is a non-volatile memory, and stores various programs and data. The communication unit 13 functions as a communication interface that executes data communication through the communication line 2.

The display 14 includes a display device that displays various messages and images. The operation unit 15 includes an operator or the like that operates the image processing device 10. The image reading unit 16 is, for example, a scanner. The image reading unit 16 optically reads an image of a content formed on a medium such as paper, and supplies image data indicative of the read image to the controller 11. The image forming unit 17 forms an image on a medium such as paper. For example, the image forming unit 17 forms an image on a sheet of paper according to an electrophotographic system by using toners of four colors including yellow (Y), magenta (M), cyan (C), and black (K). The FAX unit 18 includes a FAX modem or the like. The FAX unit 18 transmits and receives image data according to a protocol of a facsimile.

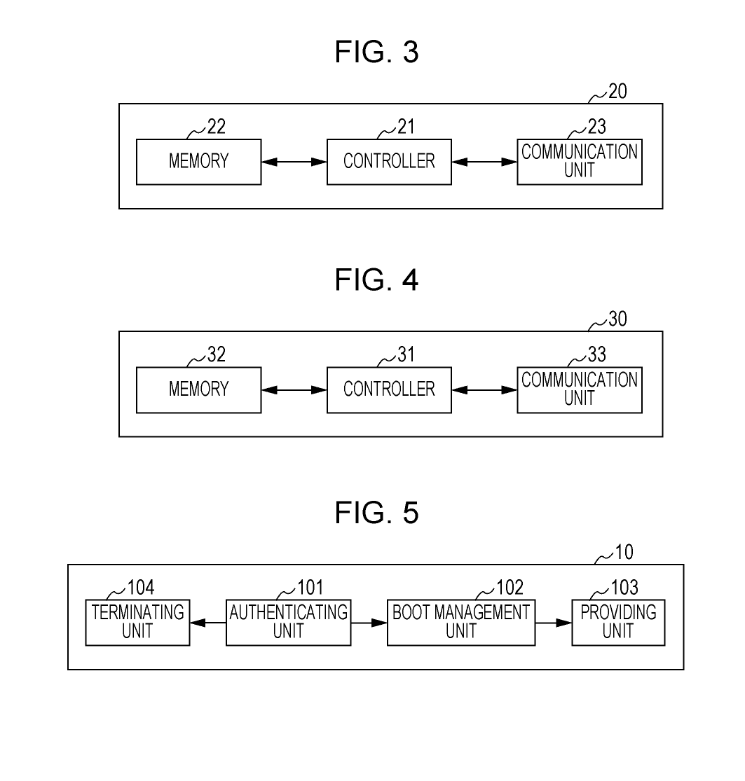

FIG. 3 illustrates a hardware configuration of the information managing device 20. FIG. 4 illustrates a hardware configuration of the license managing device 30. The information managing device 20 is a computer including a controller 21, a memory 22, and a communication unit 23. The license managing device 30 is a computer including a controller 31, a memory 32, and a communication unit 33. These are hardware with units common to those with the same names shown in FIG. 2.

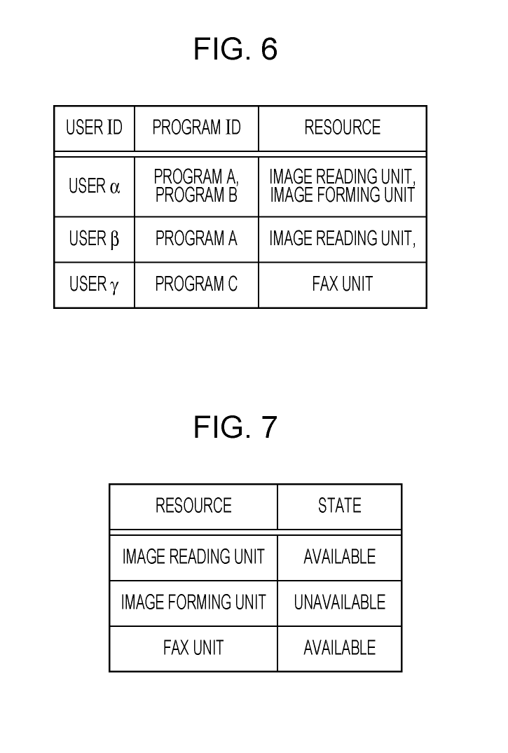

Functions shown in FIG. 5 are provided when the CPU of the controller 11 executes programs stored in the memory 12.

FIG. 5 illustrates a functional configuration of the image processing device 10. The image processing device 10 includes an authenticating unit 101, a boot management unit 102, a providing unit 103, and a terminating unit 104.

The authenticating unit 101 authenticates a user. The authenticating unit 101 stores combinations of user IDs and passwords as described above, and if a user ID and a password input by a log-in operation of a user match a user ID and a password stored in the authenticating unit 101, the authenticating unit 101 authenticates the user. Alternatively, the authenticating unit 101 may execute authentication by making an inquiry to an external device, or the authenticating unit 101 may execute authentication by using an IC card or biological information as described above. When the authenticating unit 101 authenticates the user, the authenticating unit 101 supplies the user ID of the authenticated user to the boot management unit 102. Also, when the user executes an operation of terminating the authentication (log-off operation), the authenticating unit 101 notifies the terminating unit 104 about that the user is no longer authenticated.

The providing unit 103 is described first for easier understanding of the description.

The providing unit 103 executes the above-described limited programs and provides the functions for the user. Also, the providing unit 103 provides the functions by using resources corresponding to the respective functions. The resources include a hardware resource used for providing a function (for example, respective units shown in FIG. 2) and a software resource (for example, programs and data for controlling the respective units shown in FIG. 2). In this exemplary embodiment, the above-described programs A, B, and C are limited programs. For example, the providing unit 103 executes the program A, uses resources such as the controller 11, the memory 12, and the image reading unit 16, and hence provides the scan function.

Also, the providing unit 103 provides the copy function by executing the programs A and B and using, for example, the controller 11, the memory 12, the image reading unit 16, and the image forming unit 17. The providing unit 103 provides the FAX function by executing the program C and using, for example, the controller 11, the memory 12, and the FAX unit 18. When the image reading unit 16, the image forming unit 17, and the FAX unit 18 among the resources are used to provide the functions such as the copy function and the FAX function, the image reading unit 16, the image forming unit 17, and the FAX unit 18 are resources dedicated to the functions (resources unavailable for other function while dedicated). Hereinafter, such a resource is referred to as “dedicated resource.” In contrast, a resource shared by plural functions, such as the controller 11, is referred to as “shared resource.” For example, the resources corresponding to the copy function, the scan function, and the FAX function include both the dedicated resource and shared resource.

When a function (for example, the above-described image processing function) is requested to be provided, if resources corresponding to the function are available and the execution number of limited programs does not exceed the limit, the boot management unit 102 boots the limited program. The term “boot” represents that a program is developed in a memory and becomes available to be used. Also, the “execution number” mentioned here is the number of limited programs that are to be executed as the result that the boot management unit 102 boots the limited program. That is, when the boot management unit 102 executes the limited program, the execution number is incremented by 1 as compared with the situation before the execution. However, the execution number does not still exceed the limit (in particular, the concurrently executable number of limited programs). Therefore, if the execution number does not exceed the limit although the boot management unit 102 boots the limited program, the boot management unit 102 boots the limited program. In this exemplary embodiment, the boot management unit 102 boots a limited program associated with the user authenticated by the authenticating unit 101. The limited program is a program for providing a function associated with the authenticated user.

The function associated with the user is, for example, the image processing function the kind of which to be provided is determined depending on the user by the information processing system 1. Regarding the above-described users α, β, and γ, the user α is associated with the copy function and the scan function, and the user β is associated with the scan function. Also, the user γ is associated with the FAX function. Further, the programs that are executed when these functions are provided are the programs A and B for the user α, the program A for the user β, and the program C for the user γ. In this exemplary embodiment, the information managing device 20 stores a user information table indicative of association between the respective users and these pieces of information.

FIG. 6 illustrates an example of a user information table. In the example in FIG. 6, the above described “user α,” “program A,” and “image reading unit” are respectively shown as the user ID, program ID, and resource for easier understanding of the description. Alternatively, these pieces of information may be expressed by using other numbers, characters, and symbols, as long as the users, programs, and resources are distinguished from each other. In the example in FIG. 6, as exemplarily descried above, the “user α” is associated with the “program A” and the “program B,” and with the “image reading unit” and the “image forming unit.” The “user β” is associated with the “program A” and with the “image reading unit.” The “user γ” is associated with the “program C” and with the “FAX unit.”

In this exemplary embodiment, if a dedicated resource among resources corresponding to a function requested to be provided (for example, the image reading unit 16 and the image forming unit 17 if the copy function is requested to be provided) is not used by other function, the boot management unit 102 determines that the resource is available. The image processing device 10 stores a resource state table indicative of states of respective dedicated resources.

FIG. 7 illustrates an example of a resource state table. In the example in FIG. 7, the resources of the “image reading unit,” the “image forming unit,” and the “FAX unit” which are the dedicated resources are respectively associated with states of “available,” “unavailable,” and “available.” In this case, it is indicated that the “image forming unit” is used by a certain function, and the residual two units are not used by any functions. The image processing device 10 updates the resource state table every time when the use of each resource is started and ended.

For example, when the user β is authenticated, the boot management unit 102 makes an inquiry to the information managing device 20 about the resource associated with the user β. The information managing device 20 notifies the boot management unit 102 about the “image reading unit” being the resource associated with the user β who made the inquiry. The boot management unit 102 checks the state of the “image reading unit” being the notified resource with reference to the resource state table. In this example, since the state is “available,” the boot management unit 102 makes an inquiry to the information managing device 20 about the program ID associated with the user β. The information managing device 20 notifies the boot management unit 102 about the “program A” associated with the user β who made the inquiry. Alternatively, the information managing device 20 may collectively make a single notification for the resource and the program associated with the user β. The boot management unit 102 requests the license managing device 30 to permit boot of the program A, by transmitting the identification information (program ID) of the “program A” notified as described above and the information indicative of a request to permit boot of the program A (hereinafter, referred to as “permission request”) to the license managing device 30.

Also, when the user α is authenticated, the “image reading unit” being the resource associated with the user α is “available,” however, the “image forming unit” is “unavailable.” If a resource is unavailable as described above, the boot management unit 102 reserves boot of the “program A” and the “program B” associated with the user α. To be specific, the boot management unit 102 makes this reservation by transmitting the identification information (user ID) of the “user α,” and information indicative of a request to reserve boot of the programs (hereinafter, referred to as “reservation request”), together with the identification information (program ID) of the “program A” and the “program B,” to the license managing device 30.

The license managing device 30 stores a license management table storing the executable number of limited programs and the reservation status of limited programs.

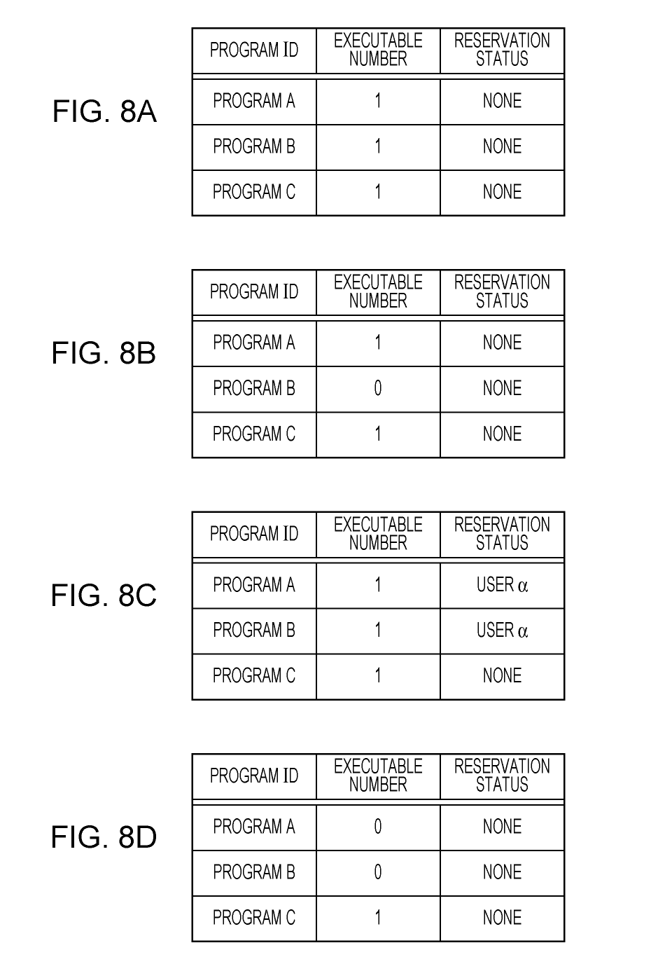

FIGS. 8A to 8D each illustrate an example of a license management table. FIG. 8A indicates that the “executable number” of each of the programs A, B, and C is “1,” ant the “reservation status” thereof is “none.” In this state, if the identification information of the “program A” and the above-mentioned permission request are transmitted from the boot management unit 102, since the “executable number” of the program A is “1,” that is, 1 or more, the license managing device 30 notifies the image processing device 10 about permission for boot of the program A, and updates the executable number of the “program A” to “0” as shown in FIG. 8B. The boot management unit 102 boots the program A in response to the notification. In this way, acquiring permission for boot of a limited program from the license managing device 30 (in this example, causing the license managing device 30 to update the executable number from “1” to “0”) is also referred to as “boot.”

Also, when the identification information of the “user α,” the “program A,” and the “program B” and the above-described reservation request are transmitted from the boot management unit 102, the license managing device 30 updates the reservation statuses associated with these programs to the identification information of the user α as shown in FIG. 8C. Then, when the states of the resources associated with the user α become “available,” the boot management unit 102 requests the license managing device 30 to permit boot of the reserved limited programs by transmitting the identification information of the user α and the above-described permission request. The license managing device 30 notifies the image processing device 10 about permission for boot of the programs A and B associated with the “user α” received together with the permission request. Then, as shown in FIG. 8D, the license managing device 30 updates the executable numbers of these programs to “0,” and the reservation statuses to “none.”

In this exemplary embodiment, the license managing device 30 does not permit boot of the limited programs even if other user makes a request until the user α makes a request of permission for boot of the reserved limited programs. That is, the license managing device 30 permits boot in order of reservation. Accordingly, when a resource which has been unavailable becomes available, the boot management unit 102 boots the limited program based on the reservation. When the boot management unit 102 boots the limited program in this way, the providing unit 103 executes the booted limited program, and provides a function such as the copy function. As described above, in this exemplary embodiment, if the dedicated resource is not used, the boot management unit 102 boots the limited program unless the execution number of limited programs does not exceed the limit. Also, if the dedicated resource is used, the boot management unit 102 makes the above-described reservation.

When the terminating unit 104 receives a notification about that the user is no longer authenticated from the authenticating unit 101, the terminating unit 104 terminates the booted limited program, and notifies the license managing device 30 about the identification information (program ID or the like) of the terminated limited program and the termination of the limited program. When the license managing device 30 receives the notification, the license managing device 30 increments the executable number of the terminated limited program by “1,” and thus updates the license management table shown in FIG. 7 or the like.

### 1-2. Operation

The respective devices included in the information processing system 1 execute providing processing of providing functions.

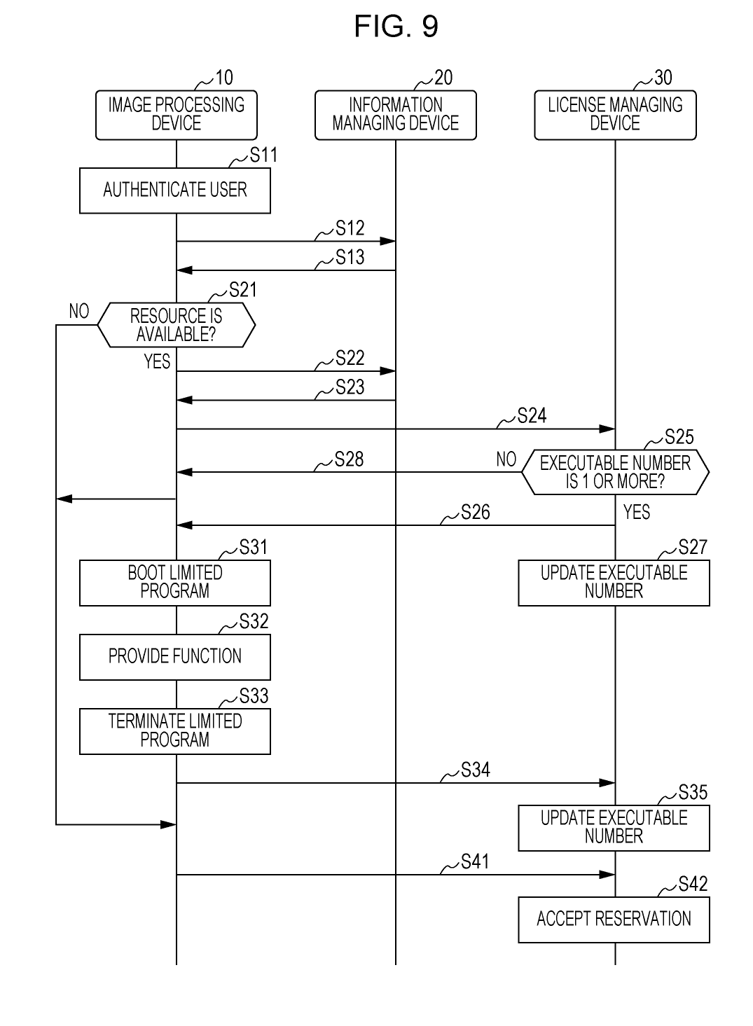

FIG. 9 illustrates an example of a sequence in the providing processing. The providing processing is started in response to an operation of authentication by a user on the image processing device 10 (for example, input of a user ID and a password). First, the image processing device 10 authenticates a user based on an operation by the user (step S11). The operation in step S11 is executed by the authenticating unit 101. Then, when the image processing device 10 makes an inquiry to the information managing device 20 about a resource associated with the authenticated user (step S12), the information managing device 20 notifies the image processing device 10 about the resource (step S13).

The image processing device 10 determines whether or not the notified resource is available. If available (YES in step S21), the image processing device 10 makes an inquiry to the information managing device 20 about a limited program associated with the authenticated user (step S22). When the information managing device 20 notifies the image processing device 10 about the limited program (step S23), the image processing device 10 requests the license managing device 30 to permit boot of the limited program by transmitting identification information of the notified limited program and the above-mentioned permission request to the license managing device 30 (step S24).

Alternatively, in step S21, the image processing device 10 may execute the operation in step S22 (the inquiry about the limited program associated with the authenticated user) first instead of determination whether or not the resource notified in step S13 is available, and then may determine whether or not the resource corresponding to the consequently notified limited program is available. In this case, if the resource corresponding to the limited program is available, the image processing device 10 executes the operation in step S24 (the request of permission for boot of the limited program).

When the license managing device 30 receives the request in step S24, the license managing device 30 determines whether or not the executable number is 1 or more. If the executable number is 1 or more (YES in step S25), the license managing device 30 notifies the image processing device 10 about permission for boot (step S26), and updates the executable number in the license management table shown in FIGS. 8A to 8D (in this case, decrements the executable number by 1) (step S27).

When the image processing device 10 receives the notification in step S26, the image processing device 10 boots the limited program associated with the authenticated user (step S31), and provides a function that is determined to be provided for the user (S32). In the example in FIG. 9, after the function is provided, a log-off operation is executed by the user, the image processing device 10 terminates the limited program (step S33), and notifies the license managing device 30 about the termination (step S34). When the license managing device 30 receives the notification, the license managing device 30 updates the executable number in the license management table (in this case, increments the executable number by 1) (step S35). The operations in steps S12, S21, S22, S24, and S31 are executed by the boot management unit 102. The operation in step S32 is executed by the providing unit 103, and the operations in steps S33 and S34 are executed by the terminating unit 104.

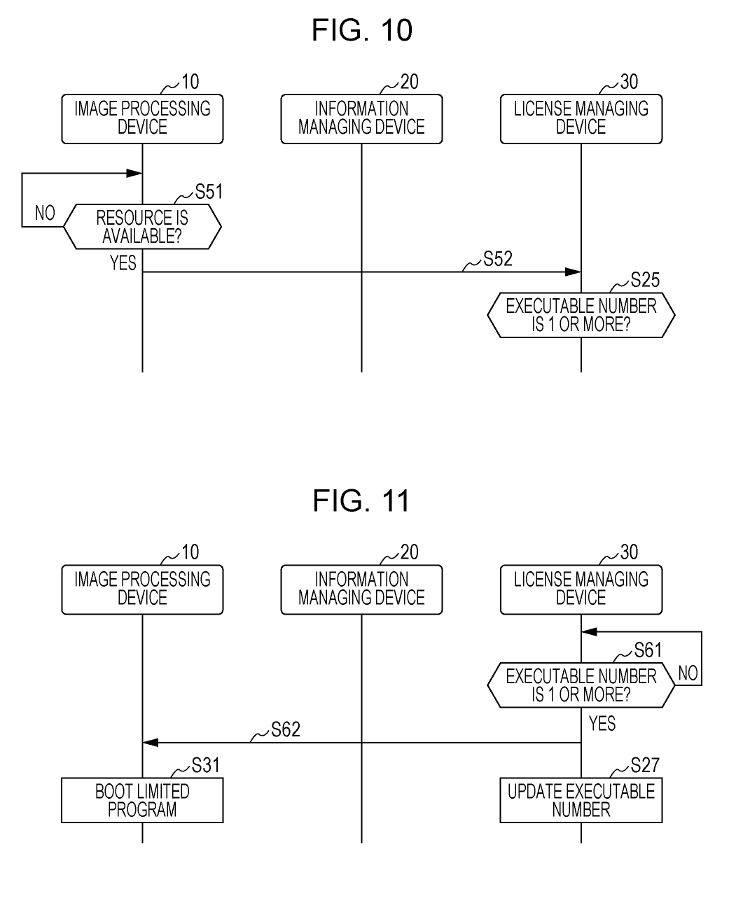

When the image processing device 10 determines that the resource is unavailable (NO) in step S21, the image processing device 10 requests the license managing device 30 to reserve boot of the limited program by transmitting the identification information of the authenticated user, the identification information of the limited program associated with the user, and the above-mentioned reservation request (step S41). The operation in step S41 is executed by the boot management unit 102. The image processing device 10 also executes the operation in step S41 even when the license managing device 30 determines that the executable number is not 1 or more in step S25 and notifies the image processing device 10 about the determination (step S28). When the license managing device 30 receives the reservation request, the license managing device 30 accepts the requested reservation by storing the identification information of the user received concurrently in, for example, the license management table as shown in FIG. 8C (step S42). The operations of the respective devices after the reservation are provided in two ways. The two ways are described with reference to FIGS. 10 and 11.

FIG. 10 illustrates an example of a sequence after the reservation. This example provides an operation when it is determined that the resource is unavailable in step S21. In this case, the image processing device 10 repetitively determines whether or not the resource becomes available (step S51). If it is determined that the resource becomes available (YES), the image processing device 10 requests the license managing device 30 to permit boot of the limited program notified in step S23 (step S52). Thereafter, the license managing device 30 executes the operation in step S25 (determination whether or not the executable number is 1 or more). Then, the operation common to FIG. 9 is executed. The operations in steps S51 and S52 are executed by the boot management unit 102.

FIG. 11 illustrates an example of another sequence after the reservation. This example provides an operation when the notification is made from the license managing device 30 about that the executable number is not 1 or more in step S28. In this case, the license managing device 30 repetitively determines whether or not the executable number is 1 or more (step S61), and if it is determined that the executable number is 1 or more (YES), the license managing device 30 notifies the image processing device 10 about the permission for boot (step S62). Thereafter, the image processing device 10 boots the limited program (step S31), and the license managing device 30 updates the executable number (step S27). Then, the operations common to those in FIG. 9 are executed.

In this exemplary embodiment, the image processing device 10 boots the limited program if the resource is available, but does not boot the limited program if the resource is unavailable. Accordingly, as compared with a case in which the program is booted regardless of the state of the resource, the number of programs to be concurrently executed is decreased, and the maximum value of the executable number (that is, the number of floating licenses) is suppressed. Also, since the image processing device 10 makes the above-mentioned reservation, as compared with a case without the reservation, the limited program is booted immediately when the resource becomes available.

In particular, in this exemplary embodiment, the reservation is made when the image processing device 10 provides the function that uses the dedicated resource. Accordingly, as compared with a case without the reservation, the program that uses the dedicated resource is booted at an earlier timing than that of the case without the reservation. Also, as compared with a case in which the program is booted regardless of the state of the dedicated resource, the number of programs that use the dedicated resource and that are concurrently executed is decreased. Also, in this exemplary embodiment, the function associated with the authenticated user is provided. Accordingly, the function is used by the user merely with the authentication by the user.

### 2. Modifications

The above-described exemplary embodiment is merely an example of implementation of the invention, and may be modified as follows. Also, the above-described exemplary embodiment and respective modifications provided below may be implemented in a combined manner according to its necessity.

### 2-1. Shared Resource

In the exemplary embodiment, the state of the dedicated resource is used for determining boot or non-boot. However, the state of a shared resource (for example, the controller 11 or the memory 12 shown in FIG. 2) may be used. For example, described is a case in which the state of the memory 12 is used as the state of the shared resource. In this modification, the information managing device 20 stores a user information table different from that of the exemplary embodiment.

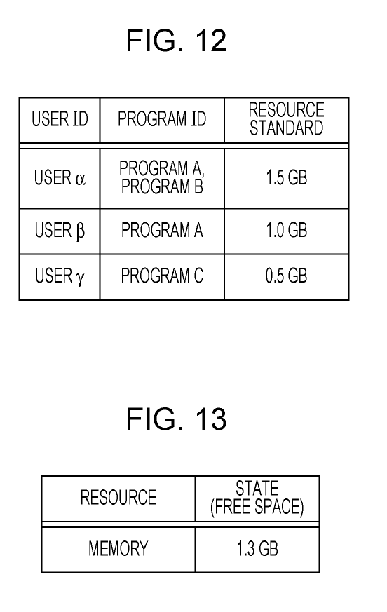

FIG. 12 illustrates an example of the user information table according to this modification. In this example, the “resource standard” is indicated instead of the “resource” in FIG. 6. The resource standard is the size of resource or the amounts of resources determined in the information processing system 1 to assign the resource to a function when the function is provided. For example, if the resource is the memory 12, the size of the storage area of the memory 12 is determined as the standard. Otherwise, when the CPU of the controller 11 includes plural cores, the number of cores may be determined as the resource standard. The resource standard is determined so that the time required for providing the function is within a range that is not noticeably separated from the time expected by a user (for example, several tens of seconds or several minutes), based on the size of resource or the amounts of resources to be used by the program when the function is provided, and the size of generated intermediate data.

In this modification, the standard is determined for the memory 12 which is the shared resource. To be specific, the size of the storage area of the memory 12, in particular, 1.5 GB (gigabyte) for the copy function, 1.0 GB for the scan function, and 0.5 GB for the FAX function, are determined as the resource standard. For example, in the case of the user α, the copy function and the scan function are provided as described above. In the image processing device 10, both functions are not concurrently provided. Hence, the resource standard of 1.5 GB being larger one is stored in the user information table in a manner associated with a user ID. Also, 1.0 GB for the user β to be provided with the scan function, and 0.5 GB for the user γ to be provided with the FAX function are stored as the resource standards respectively associated with their user IDs in the user information table.

Also, in this modification, the image processing device 10 stores a resource state table different from that of the exemplary embodiment.

FIG. 13 illustrates an example of the resource state table according to this modification. In the example in FIG. 13, the value indicative of the size of the free space of the memory 12 being the shared resource is stored as the resource state. The image processing device 10 updates the resource state table every time when the free space of the memory 12 is changed or at a predetermined temporal interval (for example, every several seconds), and reflects the latest (or as new as possible) resource state. Hence, FIG. 13 shows 1.3 GB for the value indicative of the size of the free space as the resource state. The value is repetitively updated.

For example, when the authenticating unit 101 authenticates a user, the boot management unit 102 references the resource state table, and reads stored information of the free space as a currently assignable shared resource. Also, the boot management unit 102 makes an inquiry to the information managing device 20 about the function associated with the authenticated user, and compares the resource standard associated with the function notified from the information managing device 20 with the read assignable shared resource. If the assignable shared resource exceeds the resource standard, the boot management unit 102 transmits a permission request for boot of a limited program to the license managing device 30. The boot management unit 102 boots the limited program as long as the execution number of limited programs does not exceed the limit. Also, if the assignable shared resource does not exceed the resource standard, the boot management unit 102 reserves the boot of the limited program as described in the exemplary embodiment.

Alternatively, before the boot management unit 102 reads the information of the free space (currently assignable shared resource), the boot management unit 102 may make an inquiry whether or not the execution number of limited programs reaches the limit to the license managing device 30 first, and may read the assignable shared resource if it is notified that the execution number of limited programs does not reach the limit. Even in this case, the boot management unit 102 requests the license managing device 30 to permit the boot of the limited program if the read assignable shared resource exceeds the resource standard.

In this modification, since the reservation is made when the image processing device 10 provides the function that uses the shared resource, as compared with a case without the reservation, the program that uses the shared resource may be booted at an earlier timing than that of the case without the reservation. Also, since the limited program is booted if the assignable shared resource exceeds the resource standard, the simultaneous execution number of programs that use the shared resource is decreased as compared with a case in which a program is booted regardless of the state of the shared resource.

### 2-2. Plural Image Processing Devices

The information processing system may include plural image processing devices.

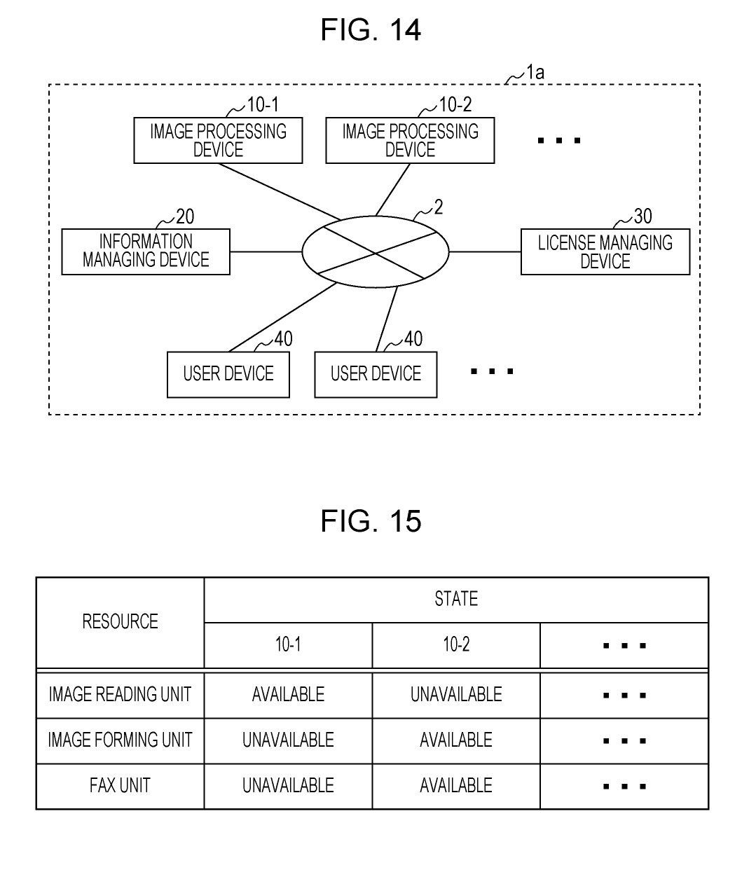

FIG. 14 illustrates a configuration of an information processing system 1a according to this modification. The information processing system 1a includes plural image processing devices 10 including an image processing devices 10-1, 10-2, . . . . In this way, if plural devices that provide the image processing functions are present, resources included in these devices are desirably effectively used. Hence, in this modification, the information managing device 20 stores a resource state table storing the states of the resources of the respective image processing devices 10.

FIG. 15 illustrates an example of the resource state table according to this modification. The resource state table shown in FIG. 15 stores the states of dedicated resources (image reading unit, image forming unit, and FAX unit) of each of the image processing devices 10-1 and 10-2. In this example, the image reading unit is available in the image processing device 10-1, but is unavailable in the image processing device 10-2. The image forming unit and the FAX unit are unavailable in the image processing device 10-1, but are available in the image processing device 10-2. When the information managing device 20 receives an inquiry from the image processing device 10, the information managing device 20 makes a notification about the states of the resources of the respective image processing devices 10 stored in the resource state table.

Even if the resource of the relevant device including the boot management unit 102 in this modification is unavailable, the boot management unit 102 makes an inquiry to the information managing device 20. If the resource of any of the plural devices is available, the boot management unit 102 transmits a permission request for boot of a limited program to the license managing device 30. This permission request is made to request permission for boot in the image processing device 10 including the available resource. Accordingly, the boot management unit 102 causes the limited program to be booted in the device available for the resource as long as the execution number of limited programs does not exceed the limit.

For example, when the user γ to be provided with the FAX function is authenticated, since the FAX unit in the relevant device (the image processing device 10-1) is unavailable but the FAX unit in the image processing device 10-2 is available, the boot management unit 102 of the image processing device 10-1 transmits the above-mentioned permission request to the license managing device 30. Thus, the program C used by the FAX function is booted in the image processing device 10-2. As described above, in this modification, the resources in the plural devices are effectively used as compared with a case in which the states of the resources of the plural devices are not considered.

Alternatively, instead of transmitting the above-mentioned permission request, the boot management unit 102 may execute the aforementioned boot by instructing the boot management unit 102 of a device available for a resource (in the above-described example, image processing device 10-2) to boot the limited program. Also, a unit that makes the instruction may be provided in a device other than the image processing device 10.

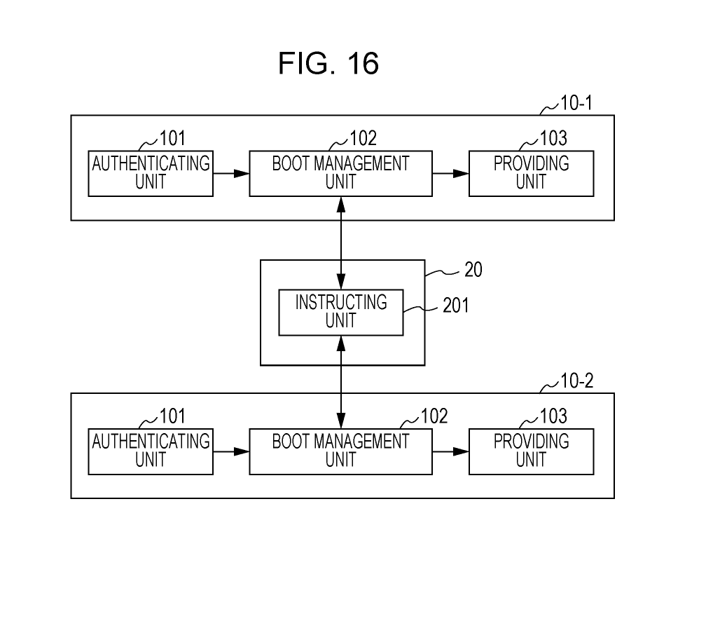

FIG. 16 illustrates an example of a functional configuration of an information processing system according to this modification. Image processing devices 10-1 and 10-2 each include respective units shown in FIG. 5. The information managing device 20 includes an instructing unit 201.

If the resource of the relevant device is unavailable, the boot management unit 102 notifies the information managing device 20 about the unavailability. When the instructing unit 201 receives the notification, the instructing unit 201 instructs another image processing device available for the resource to boot the limited program. The boot management unit 102 which has received the instruction from the instructing unit 201 boots the instructed limited program. Even in this case, if the resource of any of the plural devices is available, the boot management unit 102, the resource of the relevant device of which is unavailable, causes the limited program to be booted in the device available for the resource as long as the execution number of limited programs does not exceed the limit.

### 2-3. Configurations of Devices

The information managing device 20 and the license managing device 30 shown in FIG. 1 may be integrated. Alternatively, these devices and the image processing device may be integrated. In this case, the image processing device has the user information table shown in FIG. 6 and the license management table shown in FIGS. 8A to 8D, and manages the user information and the license information.

### 2-4. Resource of External Device

The providing unit 103 provides a function by using a resource included in the image processing device in the exemplary embodiment. However, it is not limited thereto. The providing unit 103 may provide a function by using a resource included in an external device. For example, the providing unit 103 may provide a translation function by transmitting data of a document desired to be translated to an external device having the translation function, and receiving translated data of the document from the external device. In this case, for example, the image processing device 10 executes a limited program for providing a function of requesting the external device to execute translation and outputting translated data.

### 2-5. Request for Provision of Function

In the exemplary embodiment, provision of the function associated with the authenticated user is requested. However, it is not limited thereto. For example, a logged-in user may select a function that the user wants to use, and thus provision of the selected function may be requested. Alternatively, provision of the function selected by the user may be requested regardless of being logged-in or not. Still alternatively, provision of the function may be requested even without an operation by the user as long as processing of requesting provision of the function is included in processing executed by a certain device (for example, processing of transmitting a generated document to a destination address by FAX). In any case of requests for provision of functions, the boot management unit 102 executes boot or reservation on a resource in accordance with the state of the resource as described above.

Alternatively, if plural limited programs available for a user are present, the user may select a limited program that the user uses. For example, if the user information table shown in FIG. 6 is used, the user α may use the programs A and B. The program A corresponds to the image reading unit, and the program B corresponds to the image forming unit. For example, if the user selects the program B, the boot management unit 102 executes boot or reservation in accordance with the state of the image forming unit being the resource corresponding to the selected program B.

### 2-6. Terminating Unit

In the exemplary embodiment, the terminating unit 104 terminates the limited program when the log-off operation is executed by the user and the user is no longer authenticated. However, it is not limited thereto. For example, even while the user is authenticated, the terminating unit 104 may terminate a limited program when the user executes an operation of terminating the limited program. Alternatively, the terminating unit 104 may terminate a limited program when provision of a function is ended, or when a predetermined period of time has elapsed since the end of the provision of the function.

Still alternatively, the terminating unit 104 may terminate a limited program at a different timing depending on the provided function. For example, if the copy function and the scan function are provided, the terminating unit 104 terminates the limited program when the user is no longer authenticated. If the FAX function and the print function are provided, the terminating unit 104 terminates the limited program when the provision of the functions is ended. Still alternatively, the terminating unit 104 may terminate a limited program at a different timing depending on the authenticated user, or the terminating unit 104 may terminate a limited program at a different timing depending on the booted limited program.

In either case, it is desirable to delay the timing at which the limited program is terminated more as the possibility of providing the function even if the provision of the function is ended is higher. Accordingly, as compared with that the limited program is ended at a uniform timing, a phenomenon, in which a limited program is ended when a user wants to use a function and the user has to wait for re-boot of the limited program, hardly occurs. In addition, a phenomenon, in which a limited program is continuously executed although a user does not use a function, hardly occurs.

### 2-7. Notification after Reservation

In this exemplary embodiment, as shown in FIG. 11, if the executable number of a reserved limited program becomes 1 or more, the image processing device 10 unconditionally boots the limited program. However, it is not limited thereto. For example, the license managing device 30 may notify a user about a situation in which the executable number of a reserved limited program becomes 1 through or not through the image processing device 10, and the user may execute an operation of accepting boot of the limited program. Thus, the image processing device 10 may boot the limited program. The notification for the user may be made to the user device 40, an e-mail address, or an account of SNS (social networking service) of the user. Accordingly, if there is a user who no longer uses a function after the user makes a reservation for the function, the user gets an opportunity for canceling provision of the function, and the resource and the limited program are effectively used as compared with a case without the notification.

### 2-8. Reservation of Boot

The license managing device 30 permits boot in order of reservation in the exemplary embodiment. However, it is not limited thereto. An example is provided here, in which the image reading unit and the image forming unit are used in a reservation R1 (function to be provided is copy function), the image reading unit is used in a reservation R2 (function to be provided is scan function), and the reservation R1 and the reservation R2 both reserve boot of the program A for reading an image.

In this case, although the reservation R1 is made earlier than the reservation R2, when the image reading unit becomes available while the image forming unit is unavailable, the license managing device 30 permits boot of the program A based on the reservation R2 because, even if the program A is booted based on the reservation R1, the function is not provided since the image forming unit is unavailable. Consequently, the scan function corresponding to the reservation R2 is provided by using the image reading unit. As described above, in this modification, the license managing device 30 permits boot of a program by giving a high priority to a reservation relating to a function using a resource that has become available. Accordingly, a resource and a limited program are effectively used as compared with a case in which boot is permitted in order of reservation.

### 2-9. Providing Unit

The functions provided by the providing unit 103 are not limited to the above-described functions (image processing function and translation function). Additionally, the providing unit 103 may provide, for example, a SNS function, a game function, and various functions provided by a system used in a company. That is, the providing unit 103 may provide any function as long as the function is provided by executing a limited program and using a resource corresponding to the function.

### 2-10 Category of Invention

This invention may be interpreted as an information processing device such as an image processing device; an information processing system including an image processing device, an information managing device, and a license managing device; and an information processing method of implementing processing executed by these devices. Also, this disclosure may be interpreted as a program for causing a computer such as each of the above-mentioned devices to function as the above-described respective units. This program is provided in a form of a storage medium such as an optical disc storing the program, and a form that is usable by downloading and installing the program in a computer through a network such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. At least one information processing device comprising:
a providing unit that provides at least one function by executing at least one program, a concurrently executable number of the program being limited, the providing unit providing the function by using at least one resource corresponding to the function; and
a boot management unit that boots the program when the function is requested to be provided if the resource is available and an execution number of the program does not exceed the limit,
wherein the resources include a hardware resource used for providing the function.

2. The information processing device according to claim 1, wherein the boot management unit reserves the boot of the program if the resource is unavailable, and boots the program based on the reservation when the resource becomes available.

3. The information processing device according to claim 2,
wherein the resource corresponding to the function comprises a dedicated resource dedicated to the function, and
wherein the boot management unit makes the reservation if the dedicated resource is used.

4. The information processing device according to claim 2,
wherein the at least one function comprises a plurality of functions, and the resource corresponding to the function requested to be provided comprises a shared resource shared by the plurality of functions, and
wherein the boot management unit makes the reservation if the shared resource assignable for the function requested to be provided does not exceed a standard corresponding to the requested function.

5. The information processing device according to claim 1,
wherein the resource corresponding to the function comprises a dedicated resource dedicated to the function, and
wherein the boot management unit boots the program if the dedicated resource is not used as long as the execution number of the program does not exceed the limit.

6. The information processing device according to claim 1,
wherein the at least one function comprises a plurality of functions, and the resource corresponding to the function requested to be provided comprises a shared resource shared by the plurality of functions, and
wherein the boot management unit boots the program if the shared resource assignable for the function requested to be provided exceeds a standard corresponding to the requested function as long as the execution number of the program does not exceed the limit.

7. The information processing device according to claim 1, further comprising:
an authenticating unit that authenticates a user,
wherein the boot management unit boots the program associated with the authenticated user.

8. The information processing device according to claim 1,
wherein the at least one information processing device comprises a plurality of information processing devices each having the resource, and
wherein, if the resource of a first information processing device included in the plurality of information processing devices and including the boot management unit is unavailable but the resource of a second information processing device included in the plurality of information processing devices is available, the boot management unit causes the program to be booted in the second information processing device available for the resource as long as the execution number of the program does not exceed the limit.

9. An information processing method comprising:
providing at least one function by executing at least one program, a concurrently executable number of the program being limited, the function being provided by using at least one resource corresponding to the function; and
booting the program when the function is requested to be provided if the resource is available and an execution number of the program does not exceed the limit,
wherein the resources include a hardware resource used for providing the function.

10. A non-transitory computer readable medium storing a program causing a computer to execute a process for information processing, the process comprising:
providing at least one function by executing at least one program, a concurrently executable number of the program being limited, the function being provided by using at least one resource corresponding to the function; and
booting the program when the function is requested to be provided if the resource is available and an execution number of the program does not exceed the limit,
wherein the resources include a hardware resource used for providing the function.
